(19) United States
(12) Patent Application Publication
(10) Pub. No.: US 2024/0143090 A1
(43) Pub. Date: May 2, 2024

(54) METHOD FOR OPERATING AN INPUT SYSTEM

(71) Applicant: Inventus Engineering GmbH, St. Anton i.M. (AT)

(72) Inventors: Stefan Battlogg, St. Anton i.M. (AT); Benjamin Bürkle, Bürs (AT)

(21) Appl. No.: 18/546,308

(22) PCT Filed: Feb. 14, 2022
(86) PCT No.: PCT/EP2022/053508

§ 371 Date: Aug. 14, 2023

(30) Foreign Application Priority Data
Feb. 14, 2021 (DE) 10 2021 103 427.2

(51) Int. Cl. G06F 3/0354; G06F 3/01

(52) U.S. Cl. CPC G06F 3/03548; G06F 3/016

(57) ABSTRACT

A method for the operation of an input system with a control element for making inputs into an input-receiver, where the control element can be translated in a movement plane, and a guidance system for the biaxial guidance of the control element in the movement plane along an x-axis and a y-axis. Mobility of the control element in the movement plane is influenced in a controlled way by the guidance system at least during an input. The control element is braked by means of a controllable braking apparatus. The movements performed with the control element are registered and evaluated. A prediction for the target region of the movements is calculated therefrom. The mobility of the control element is influenced by means of the guidance system in accordance with the prediction for the target region.

### FIELD OF THE INVENTION

The present invention relates to a method for operating an input system with an operating element that can be displaced in a movement plane for making inputs into an input receiving device.

Such input systems are known, for example, as (computer) mice. The user moves the mouse on the table with his hand, looks at the cursor with his eyes and thus directs the cursor to the target position on the screen. Usually there is a zigzag movement and first rough movements, then finer movements with increased concentration (looking closely) in order to hit the target.

Thus, hand-eye coordination is required for inputs with such devices, which requires the user's attention to a great extent. However, this is particularly disadvantageous when the user must not be distracted and has to concentrate heavily on the input itself, for example with certain computer programs or computer games, when driving a car or when operating drones or other devices.

DE 19626 249 A1 therefore discloses an input unit for an operating system for vehicle screen systems, which provides guidance for the operating element along the X-Y axis. The control is used to move a cursor on a display. In this case, an electromotive holding or actuating device acts on the operating element, so that its mobility in the x or y direction is enabled or blocked. As a result, the control element within a program becomes a sub-function after initiating the transition or after completing the main function along a computer selected and enabled shift direction to the next switching position provided in the program. By means of a target/actual comparison of the positions of the cursor and the control element, the control element can also be automatically positioned via the electromotive adjustment device.

In contrast, it is the object of the present invention to provide an improved possibility for carrying out inputs. In particular, a targeted and at the same time comfortable or ergonomic input should be possible without the user being unfavorably distracted. It is also desirable that the user can also be assisted in carrying out the input. On the one hand, the movement should be guided as safely as possible, but on the other hand, the user should be restricted as little as possible or not at all in his choice of operation.

This object is achieved by a method having the features of claim 1. Preferred developments of the invention are the subject matter of the dependent claims. Further advantages and features of the present invention result from the general description and the description of the exemplary embodiments.

The method according to the invention serves to operate an input system with an operating element that can be displaced (in particular manually) in a plane of movement for carrying out (in particular manual) inputs into an input receiving device. In particular, the operating element is at least partially manually displaced in the plane of movement in order to carry out an input. The input system includes a guidance system for two-axis guidance of the operating element in the movement plane along an x-axis and a y-axis. A movability (movement) of the operating element in the plane of movement is influenced in a targeted manner at least during an input (or during a movement carried out for the input) with the guidance system. For this purpose, the operating element is braked by means of a controllable braking device. In particular, the control element can additionally or alternatively by means of a drive device are moved at least supporting. In particular, the manual movement of the operating element is supported. The operating element can also be moved (at least temporarily) driven solely by the drive device. In particular, the movements performed with the operating element are registered and evaluated. In particular, a prediction for the target area of the movements is calculated from this.

In particular, the mobility of the control element is influenced by the guidance system (at least also) taking into account the prediction for the target area. Preferably, the movements performed with the operating element are thereby guided to the target area without the movements being restricted to the target area. In particular, movements deviating from the target area are possible and are preferably also supported.

The method according to the invention offers many advantages. The targeted influencing of the movement of the operating element through the guide system offers a considerable advantage. This supports the user with his input and guides his movements so that both simple and complex inputs are possible comfortably and ergonomically. In addition, the user is less distracted by the support and can concentrate on the actual operation. For example, with the present invention it is possible to make an input with the control element with your eyes closed, because the travel path can be specified by braking (passive) or the drive (active). The guide system allows the hand to be guided in such a way that unnecessary movements are reduced (avoidance of a “mouse arm”) and the eyes and concentration are spared. A particular advantage is that the guide of the manual movement is very safe and yet not “rigid.” The guidance is dynamic and intelligent and can react quickly to individual conditions.

The movements are preferably evaluated continuously. In particular, the prediction is continuously corrected and/or recalculated with the current data of the evaluation. This preferably results in a dynamic prediction for the target area. In this way, a spontaneously changed user request can be quickly recognized and taken into account. Such a situation is, for example, when the user suddenly no longer wants to reach the volume control on the display, but wants to press the button to change the music track.

In all of the configurations, it is preferable for the movements to be evaluated and/or the target area to be predicted using at least one machine learning algorithm. Such an algorithm can also be referred to as artificial intelligence. In particular, the algorithm can continuously optimize itself by evaluating its own calculations or predictions and/or user behavior. In this way, the forecasts can be constantly improved.

In order to predict the target area, it is preferably evaluated how consistently (directly) the movements of the operating element run in a specific direction. If the control, e.g., is moved over a certain distance across or directly opposite to the prediction, then the prediction is discarded as improbable and recalculated using more recent data. A measure of the consequence (determination) is, e.g., the time (duration), the distance, the force and/or the angular deviation of the movement.

The mobility of the operating element is particularly preferably influenced by the guidance system in such a way that the operating element can be moved in the direction of the predicted target area with less resistance than in directions deviating from it. In particular, the greater the deviation from the direction of the predicted target area, the higher the resistance is set. For this purpose, the braking device can adjust the resistance for the mobility of the operating element in real time. The resistance is generated in particular by the braking device. The predicted target area is preferably corrected at least when the operating element is pressed against the resistance of the braking device above at least one limit value. The limit value can, e.g., describe a time (duration), distance, angular deviation and/or force. It can also be taken into account how consistently (e.g., with what angular deviation) the operating element is pressed in the opposite direction to the predicted target area. In particular, the correction takes place at least when the operating element is pressed against a certain increased resistance for a longer period of time. In other words, if resistance is pushed consistently and/or very hard, then the prediction is discarded as unlikely and, in particular, recalculated using more recent data.

In particular, in order to predict the target area, it is at least also taken into account whether the input receiving device specifies at least one area in which the input is to be made. In particular, this (virtual) area then specifies the (physical) area into which the control element is to be moved as part of the input. For example, a message appears on the display of the input receiving device, which must be acknowledged with “OK” or “reject.” As a result, the areas in which the operating element must be moved so that the cursor is on “OK” or “reject” are recognized as target areas. By further monitoring the movement, it can then be calculated very quickly and reliably whether the user is aiming in the direction of “OK” or “reject.”

The target areas actually driven to are particularly preferably registered and, in particular, evaluated by means of a machine learning algorithm, so that the reliability of the predictions can be continuously optimized. In particular, this takes place during one or more sessions (sessions). In particular, the predictions can be compared with the destination areas actually headed for. User preferences can also be recognized from the destinations actually headed for. Then can for future predictions also take into account user preferences. This further improves reliability.

For example, a graphical user interface of a spreadsheet includes an area for the table and an area (menu bar) for functions and settings. If the cursor is in the menu bar, the resistance for movements that would lead to exiting the menu bar is increased. This prevents you from leaving the menu bar unintentionally. If the user still wants to leave the menu bar and switch to the table area, he can simply “overpress” the higher resistance. Then movements in the table area are possible again with a lower resistance. If, for example, numerical values are copied from a cell the clipboard, a haptic grid is automatically activated. This means that a short resistance must always be “pressed over” when changing from one column, row, or cell to another. In this way, the correct cell in which to insert the numerical value can be found intuitively. Depending on the behavior of the user when the help is active, the algorithm learns and optimizes the help for the future. If, for example, accidental overpressing of the desired cell is more common due to physical impairment, the resistance can be adjusted. If certain aids are deactivated by “clicking”, these are no longer or rarely activated. Functions in the menu bar, which are frequently activated after a certain movement or function, are recognized by the algorithm.

This then helps by specifically braking the movement of the control element guide the cursor to such functions in the menu bar.

It is possible and advantageous that, for an input in which the control element is to be moved to a target point, the mobility of the control element is influenced by the guidance system in such a way that the control element can only be moved to the target point along a path that is no more than 15% and preferably no more than 10% and particularly preferably no more than 5% from the shortest (direct) path. It is also possible that the control element can only be moved along the shortest possible path. The shortest route is understood to mean, in particular, a direct route between a starting point and the destination. This effectively avoids unnecessary and stressful movements.

It is also possible and preferred that for an input in which the control element is to be moved to the destination via at least one intermediate point, the mobility of the control element is influenced by the guidance system in such a way that the control element can only be moved to the destination point via the intermediate point. For example, the target point is a field for confirming a selection in a program. The intermediate point is then, for example, a field that must be clicked on before confirmation, for example an information field or security query. Two or more intermediate points can also be provided.

It is preferred that for an input in which the control element is to be moved to a target point, the mobility of the control element is specifically slowed down by means of the guidance system and/or influenced with haptic signals when the control element approaches the target point and/or the target point reached and/or removed from. Such an embodiment can also be referred to as capture mode. By specifically influencing the movement in the vicinity or at the target point, the control element is “captured.” For example, a cursor can be moved safely and comfortably to a desired position on a display, even if the user is sitting on a construction machine with vibrations.

In particular, the catch mode can be overcome by moving the operating element further with an increased expenditure of force. It is also possible that the movability is blocked in catch mode, so that no further movement of the control element is possible even with increased effort. This is an advantage, for example, if a dangerous or critical input has to be prevented, for example when operating a machine outside the safe operating state.

In particular, mobility is made more difficult and/or blocked when the operating element approaches or reaches the target point. Preferably, the operating element can also be braked with at least one haptic signal when it is approaching or reaching the target point. A sliding approach to the target point and/or the intermediate point is preferably provided. For example, when the target point is reached, more damping can take place, so that the user can actually feel that the target point has been reached. This is advantageous, for example, if menu items of an office program or other selection areas are to be reached on a display as part of the input.

Preferably, for an input in which the operating element is to be moved along a defined movement path, the mobility of the operating element is specifically slowed down by means of the guidance system and/or influenced with haptic signals and/or actively supported (e.g. actively pushed back onto the movement path), if the operating element deviates from the trajectory by a certain amount.

For example, a virtual person walks through a virtual scenario and a building. The trajectory then corresponds to the movement options provided in the scenario, for example restricted by the walls of the building. Such a trajectory can also be specified by a safe or required trajectory of a drone or trajectory of a machine or vehicle. Such movement paths can also be provided in software with selection options or when drawing with a drawing program. The movement path is defined in particular by a large number of movement directions and/or points (X-Y positions) in the movement plane.

It is also preferred that for an input in which the operating element along a defined path of movement is move, the movability of the operating element is released in a targeted manner by means of the guidance system and/or influenced with haptic signals and/or actively supported when the operating element is approaching the trajectory and, in particular, is approaching again after a deviation. This allows the user to safely and easily find their way back to the desired trajectory.

The braking and/or the haptic signal and/or the active support preferably increases as the deviation from the movement path increases. The braking and/or the haptic signal and/or the active support preferably becomes weaker as the movement path approaches. The active support can also “push along” more the closer you get to the movement path.

The strength of the haptic signal can correspond, for example, to the frequency of a vibration or rattling. The strength of the haptic signal can also be defined, for example, by the force required to move the control element further.

In all of the configurations, it is possible and preferred that for an input in which the operating element is to be moved to a target point and/or along a defined movement path, the operating element is at least temporarily actively moved or even exclusively actively moved by means of the guidance system. This can be advantageous, for example, in order to facilitate or automatically return to a selection point in software or to a safe trajectory for a drone or to a safe operating position for a machine.

In particular, active co-moving and braking can be provided in parallel. For example, the vehicle brakes when deviating and actively moves when it approaches. For example, the change between moving and braking can take place in real time.

In all of the configurations, it is preferred and advantageous for a movement path and/or a target point for an input to be determined automatically. The trajectory and/or the target point are particularly preferably determined as a function of the situation. In particular, the trajectory and/or the target point are determined using artificial intelligence. In particular, a machine learning method is used for this purpose. By recognizing the target point or the movement path, unfavorable or dangerous inputs can then be blocked or made more difficult and favorable inputs can be supported or even carried out automatically.

In all of the configurations, it is possible and advantageous for the movability of the operating element with the guidance system to also be influenced as a function of what input is made in the input receiving device. For example, mobility can be influenced depending on how sensitively or exactly an input has to be made. For example, greater support is provided for drawing fine structures than for selecting large elements or menu areas. In particular, the input receiving device sends control commands to the management system for this purpose. In particular, mobility of the operating element with the guidance system can also be influenced as a function of a control command from the input receiving device.

In particular, the mobility of the operating element can be influenced as a function of a virtual scenario. In particular, mobility is slowed down all the more, the higher a force to be fictitiously used in the scenario and/or the more difficult an action to be fictitiously carried out in the scenario is. At least one haptic signal is preferably generated as a function of the scenario. For example, a rattling that can be felt on the control element is generated if a vehicle has to drive over an uneven surface in the scenario. In particular, the scenario is simulated using software.

Dampening the movement of the control element (in the form of a computer mouse) in office applications can show the size of files and folders when they are moved by the user in the location, the user feels the virtual weight. Large files or folders that take up a lot of disk space feel “heavy” to the user. The cushioning is increased, making it more difficult to move the mouse. Smaller folders and files are easier to move around, the cushioning is set smaller.

The mobility of the operating element can preferably be influenced as a function of a real situation. The mobility is preferably slowed down and in particular blocked if a critical operating state would otherwise be generated in the real situation. For example, the mobility of the operating element is influenced depending on the operating state of a drone or a vehicle. The mobility is then slowed down or even blocked if a critical flight movement or driving movement is to be carried out with the drone or the vehicle.

In particular, mobility of the operating element with the guidance system can be influenced as a function of an acceleration and/or speed of the operating element. In this way, movements of the control element that are too fast or jerky can be dampened.

In all of the configurations, it is preferred that the operating element is braked in a targeted manner as a function of location. In this way, in particular, a grid can be haptically simulated. In particular, the operating element cannot be moved any further at a latching position of such a latching without additional expenditure of force.

In particular, mobility of the control element can be influenced with the guidance system in such a way that the control element can be displaced along a movement path with a plurality of latching positions and/or location-dependent blocks. In particular, this allows a setting mechanism and, e.g., an H circuit can be simulated. In particular, any trajectories with possible branches and dead ends can be reproduced haptically with or without a grid (i.e., noticeable on the control element). This can also be an advantage if certain movement sequences are to be trained or learned, for example to learn inputs for software or during rehabilitation.

The operating element is preferably designed to be pressure-sensitive. In particular, the input is also made as a function of the pressure on the operating element. For example, when gaming, a virtual person can jump higher the harder the control element is pressed. It is also possible for a parameter and, for example, a volume to be adjusted more quickly as a function of the pressure. It is also possible for the control element to be in the form of a switch (press switch, rocker switch . . . ) and for an input to be able to be made by pressing the control element. It is possible that a previously performed influencing of the mobility and, for example, a blockage can be canceled by pressing on the operating element.

The operating element is preferably designed as a fingerprint sensor. In particular, the movability of the operating element is influenced as a function of a detected fingerprint. For example, entries for unauthorized users can be blocked in this way.

In an advantageous development, the mobility of the control element is influenced to support inputs and/or to support learning of input capabilities. For this purpose, movements on certain movement paths are specifically supported and/or prevented. This allows newcomers or older people to be guided in learning computer skills and can also receive tangible feedback.

Preferably, the mobility of the operating element is between freely movable and blocked with a frequency of at least 10 Hz and preferably at least 15 Hz or higher switchable. As a result, haptic signals that are particularly easy to perceive can be generated. By adjusting the frequency, the signals can then be made stronger or weaker, for example.

In particular, the movability of the control element can be set from freely movable to completely blocked for the force that can be generated manually on the control element during operation. In particular, after an input, the mobility of the operating element can be delayed or blocked until at least one further user input has taken place (e.g. by pressing on the operating element). In particular, the mobility of the operating element is adjusted in real time.

In the context of the present invention, “release” is understood in particular to mean that there is only an operational basic torque of the braking device, without an additionally applied (magnetorheological) deceleration, for example by energizing a coil device of the braking device.

The guidance system is preferably controlled with an adaptive algorithm. In particular, the mobility of the input element is influenced with an adaptive algorithm. In particular, the adaptive algorithm is based on a method of machine learning or artificial intelligence. For example, the braking torque or the haptic signals can be automatically adjusted to the strength or habits of the user.

In the context of the present invention, a haptic signal is understood to mean, in particular, a targeted sequence of (rapidly) changing braking torques and/or drive torques (also called ripples/tics/rasters). In particular, the user feels the haptic signal as a vibration. It is also possible that an increased effort to move the operating element further is provided as a haptic signal. Then, for example, a (force) further pressing of the control element is necessary to continue the input or to overcome a detent position.

In all of the configurations it is possible for the haptic signals to be supplemented and/or replaced with acoustic and/or optical signals. In particular, the guidance system includes acoustic and/or visual signal transmitters. It is also possible for the acoustic signals to be converted into an audible frequency range by blocking and releasing mobility by means of the braking device.

In the context of the present invention, influencing the mobility of the operating element is understood to mean a passive and/or at least partially active specification of a movement direction and/or movement path. The mobility of the operating element is preferably specified only by the braking device (that is to say purely passively; only by braking). However, it is also possible for the operating element to be influenced in such a way that it is (completely (i.e., without manual movement) or partially (i.e. in addition to manual movement)) actively displaced by means of the drive device in a specific movement direction and/or along a specific movement path. For example, an active reset to a rest position (zero position) can take place. All of the configurations provide for both positive and negative (haptic) feedback for the executed movement of the control element. It is possible that the drive device is provided (only) for such feedback.

In particular, the guidance system comprises at least one braking device and/or drive device for each arm. The braking device is preferably designed to be magnetorheological. The braking device comprises in particular at least one magnetic field-sensitive magnetorheological medium (particularly liquid or gaseous carrier medium with solid particles) and at least one (magnetic) field generating device (particularly electric coil device) assigned to generate and control a field strength. In particular, the mobility of two damper components or braking components of the braking devices that can be moved relative to one another is subjected to a deceleration torque in a targeted manner by the field generating device and the medium. In particular, a deceleration moment is set by controlling the field generating device with a specific current and/or a specific voltage or a suitable signal.

The braking devices and/or drive devices can preferably be controlled in particular by means of at least one control device as a function of a sensor-detected position of the arms. In particular, damping can be adjusted depending on the position of the arms. In particular, different damping can be set for the arms. In particular, the braking devices can be adjusted in real time by means of the control device. For example, a haptic signal or haptic feedback can take place if the arms are moved as part of manual operation or an input is made with the control element.

In particular, it is driven and/or braked along the two-axis guide. In particular, one or both axles are braked and/or moved. In particular, the movement in one or both directions (forward and backward) along one axis can be braked and/or driven. In particular, certain points in the movement plane (X-Y position) can be blocked and/or approached in a targeted manner.

The invention can also be used advantageously for compound tables in machine tools and milling machines, for example. Advantageously, the invention can also be used to move sample tables, e.g., in microscopes are used. The invention can also be used to advantage for other applications that require a precise two-axis movement.

The applicant reserves the right to claim a management system which is suitable and designed to carry out the method.

Further advantages and features of the present invention result from the exemplary embodiments, which are explained with reference to the enclosed figures.

In the figures show:

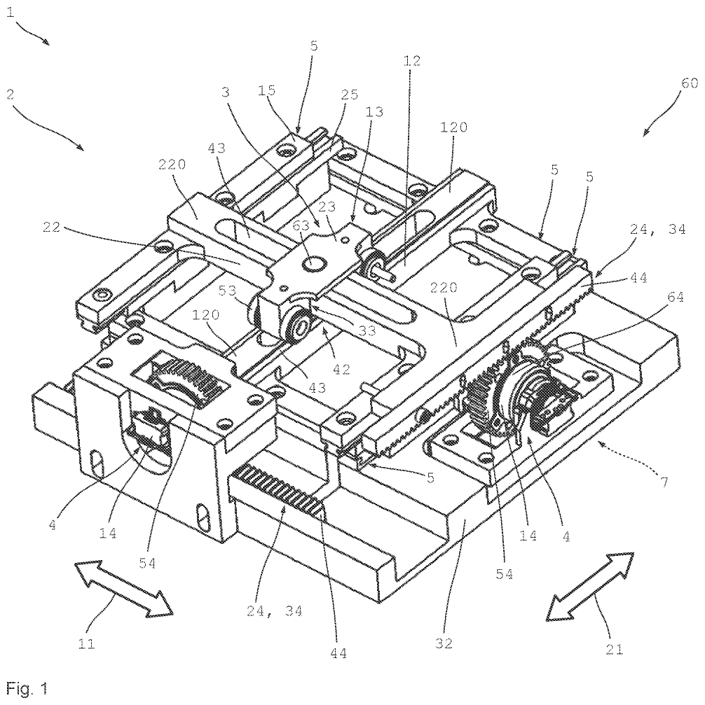

FIG. 1 shows a purely schematic representation of a guide system in a perspective view obliquely from above;

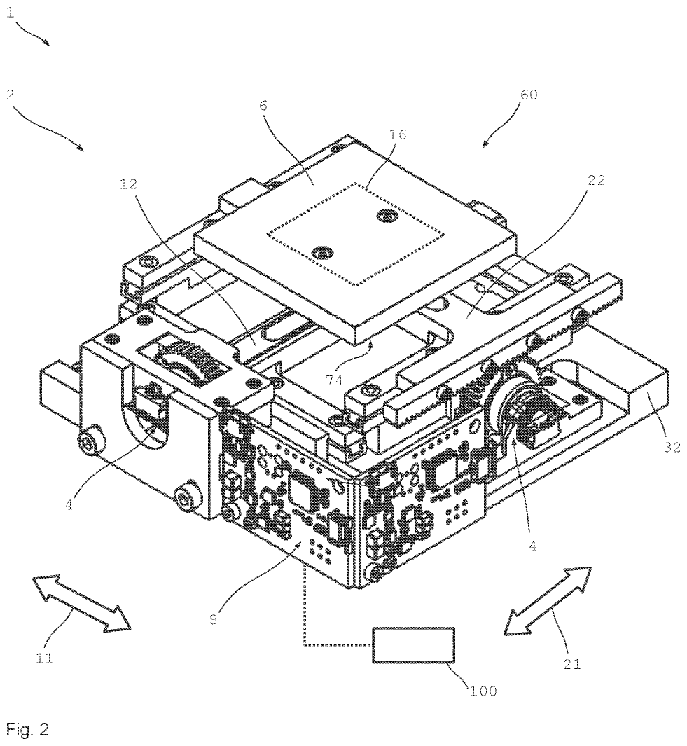

FIG. 2 is another purely schematic representation of a guidance system according to FIG. 1 in a perspective view obliquely from above;

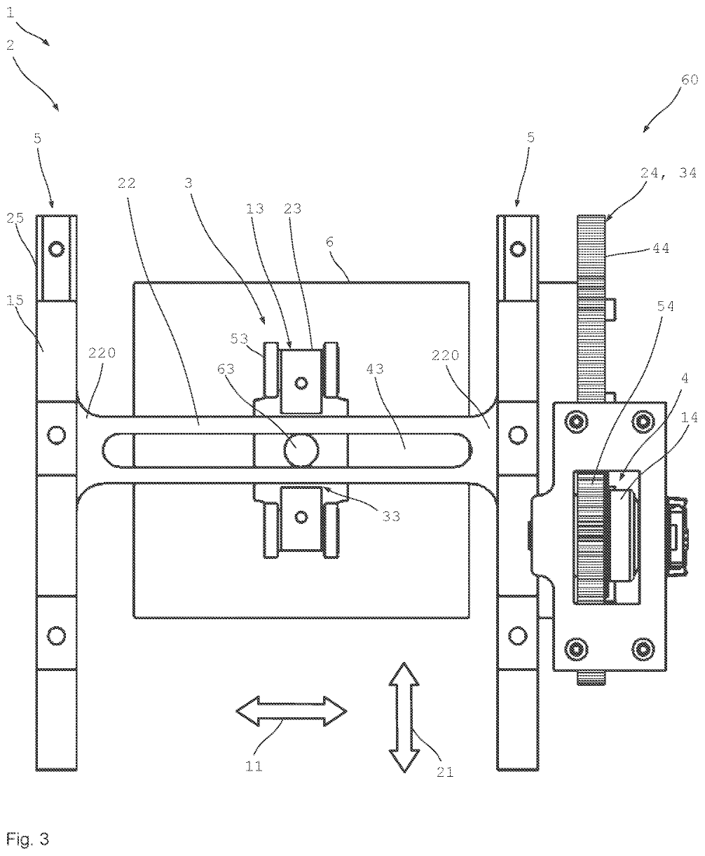

FIG. 3 shows a detailed representation of the guide system according to FIG. 2 in a view from below;

FIG. 4 shows a detailed illustration of the guide system according to FIG. 1 in a perspective view obliquely from below;

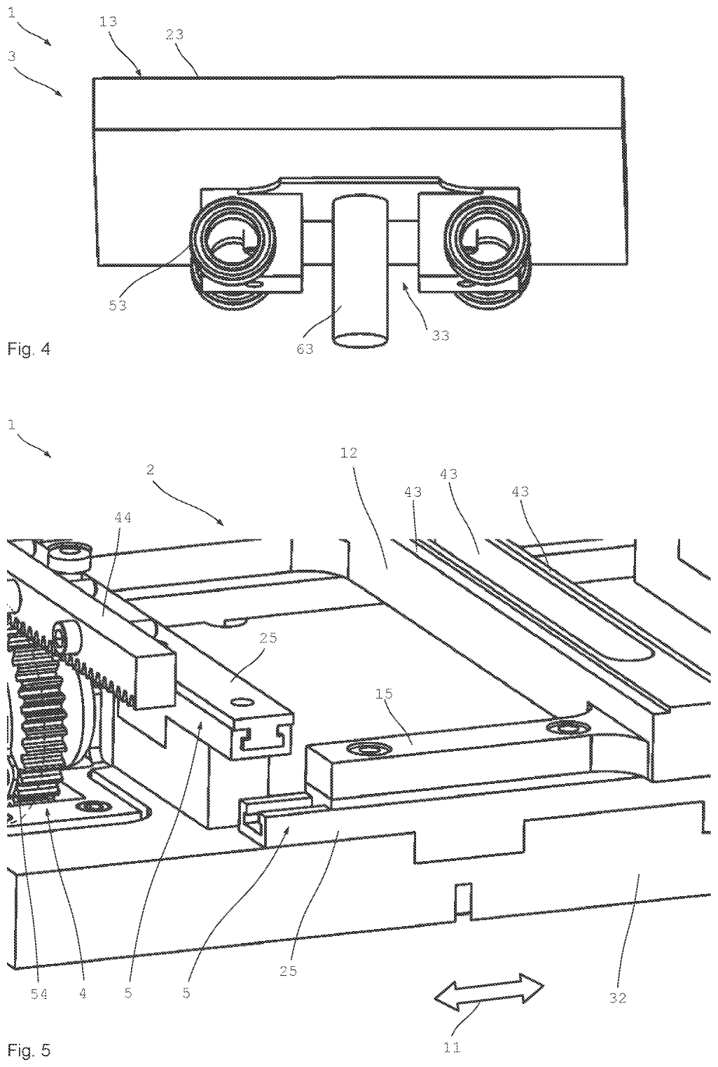

FIG. 5 shows a further detailed representation of the guidance system of FIG. 1 in a perspective view obliquely from above; and

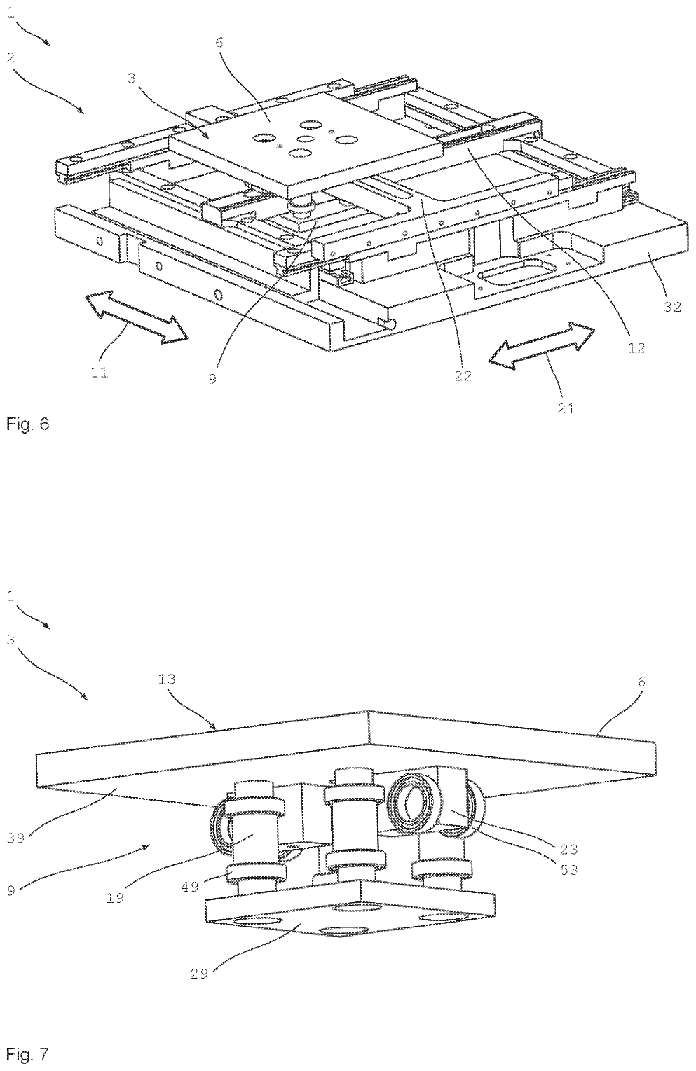

FIG. 6 shows a purely schematic representation of the guide system with a coupling device with a coupling unit in a perspective view obliquely from above;

FIG. 7 is a detailed representation of the coupling device of the guidance system according to FIG. 6 in a perspective view obliquely from below;

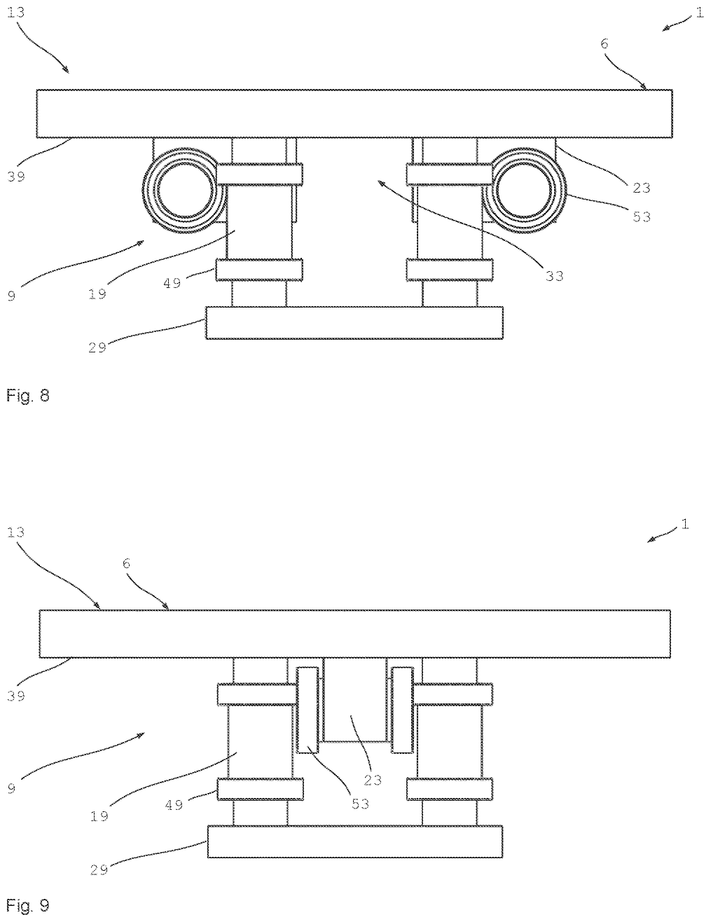

FIG. 8 shows the coupling device according to FIG. 7 in a side view;

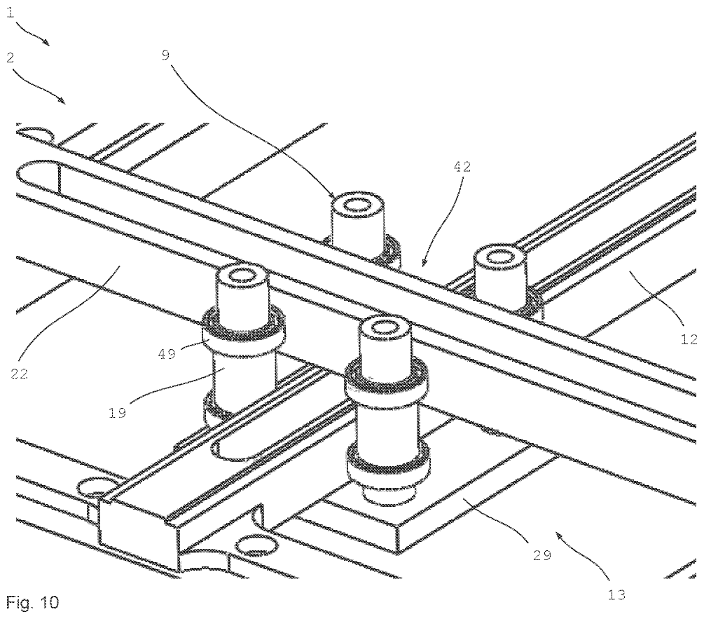

FIG. 9 shows the coupling device according to FIG. 7 in a front view;

FIG. 10 shows a detailed illustration of the guide system according to FIG. 6 in a perspective view obliquely from above;

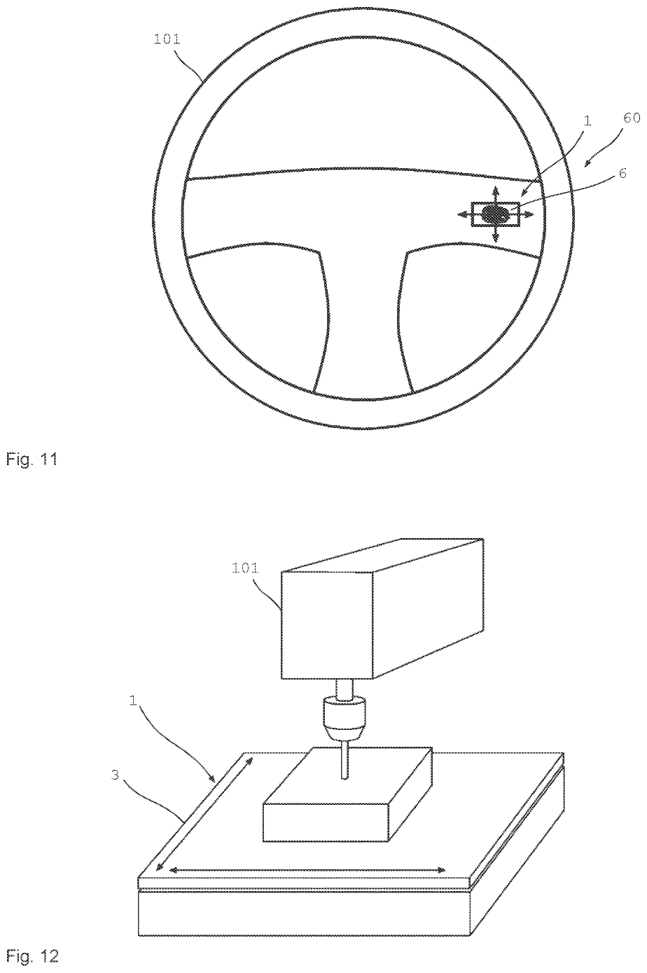

FIG. 11 shows a purely schematic illustration of a steering wheel with a guidance system;

FIG. 12 shows a purely schematic representation of a machine tool with a guide system; and

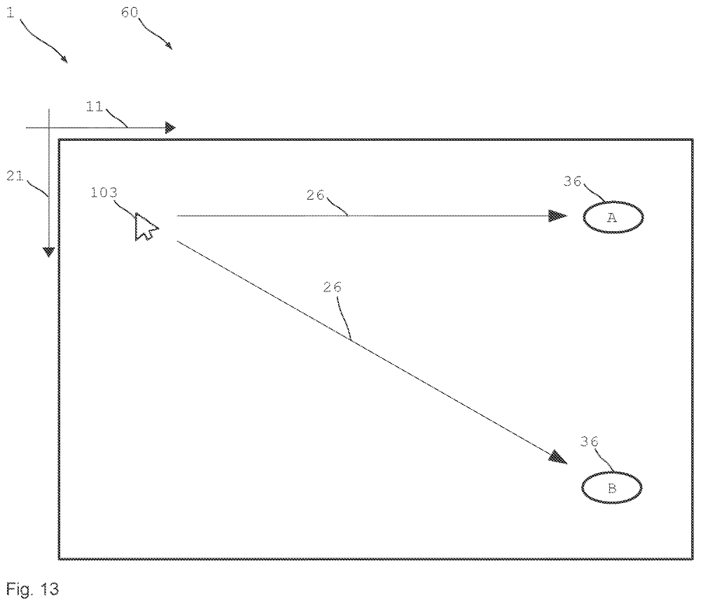

FIG. 13 shows a sketch for carrying out inputs with the management system.

FIG. 1 shows a guidance system 1 for guiding a movement along an x-axis 11 and a y-axis 21. The guidance system 1 comprises a guidance device 2 with a first arm 12 and a second arm 22 and with a support structure 32.

With reference to FIG. 1 and the detailed representations of FIGS. 3 to 5, the guidance system 1 is described below by way of example.

The first arm 12 is slidably mounted on the support structure 32 along the x-axis 11. The second arm 22 is mounted on the support structure 32 so that it can be displaced along the y-axis. Thus, the x-axis 11 can also be referred to as the movement axis of the first arm 12 and the y-axis 21 as the movement axis of the second arm 22.

The arms 12, 22 are each mounted on the support structure 32 with two linear guides 5 each. A detailed representation of the linear guides 5 is shown in FIG. 5. The linear guides 5 are each arranged on opposite end regions 120, 220 of the arms 12, 22. Overall, the linear guides 5 are arranged in an H-shape here.

The linear guides 5 each include two slide rails here 15, 25. Of these, a slide rail 25 is fixed to the support structure 32 and a slide rail 15 to the arm 12, 22. Here, one slide rail 25 grips the other slide rail 15 in a form-fitting manner, resulting in a dovetail connection. As a result, the rotary dampers 14 remain stationary together with their gears 54 on the support structure 32, while the racks 44 move together with the arms 12, 22. The slide rails 15, 25 can be made of friction-reducing material or coated with it.

The arms 12, 22 intersect at a crossing point 42 and are connected to one another there by means of a coupling device 3 so that they can be moved in a targeted manner. The coupling device 3 includes a coupling element 13 which is provided here by a carriage 23 and a coupling rod 63. A detailed representation of the carriage 23 and the coupling rod 63 is shown in FIG. 4. In alternative configurations, only the carriage 23 or only the coupling rod 63 for coupling the arms 12, 22 can be provided.

The carriage 23 is mounted here on the first arm 12 by means of four rollers 53. In each case, two rollers 53 arranged in a track run in a guide groove 43 of the first arm 12. The carriage 23 has a passage 33 through which the second arm 22 extends.

The coupling rod 63 extends here through a guide groove 43 designed as an elongated hole, which is arranged in the second arm 22. From there, the coupling rod 63 extends further into a guide groove 43, also designed as a slot, of the first arm 12. The coupling rod 63 also extends through the carriage 23 here.

The coupling device 3 and its arrangement on the second arm 22 can be seen particularly well in the detailed representation of FIG. 3. There is the second arm 22 with its linear guides 5 and the braking device 4 shown from below. It is particularly easy to see how the second arm 22 extends through the passage 33. The coupling rod 63, which extends through the guide groove 43 designed as a slot in the second arm 22, is also clearly visible.

If the carriage 23 is moved along the x-axis 11, it pulls the upper or second arm 22 along with it in the x-direction. In the middle of the carriage 23 is the slot or a bore through which the coupling rod 63 can pass. The coupling rod 63 protrudes into the lower or first arm 12. Thus, the first arm 12 is also moved when the carriage 23 is moved or pulled along the y-direction.

The coupling device 3 shown here has the particular advantage that the arms 12, 22 only move in one (their) direction (either the x-direction or the y-direction). Thus, the braking devices 4 described below can be fixed in one place and do not have to be movable. Only the coupling element 13 and possibly the operating element 6 located thereon can move in the x and y direction.

The movements of the arms 12, 22 are damped here by means of a braking device 4 each. The braking devices 4 are designed here as rotary dampers 14 and are fixed in place on the supporting structure 32. The linear movements of the arms 12, are converted into rotary movements of the rotary dampers 14 by means of a gear mechanism 24 designed here as a rack and pinion gear 34.

Here, the rotary dampers 14 are each equipped with a gear wheel 54 which meshes with a toothed rack 44. The toothed racks 44 are each arranged on an end region 120, 220 of the arms 12, 22 here. The racks 44 run parallel to the movement axis 11, 21 of the arms 12, 22 and parallel to the linear guides 5. The rotary dampers 14 remain together with their gears 54 stationary on the support structure 32 while the racks 44 move with the arms 12,22. So that the toothed racks 44 do not collide with one another, the lower toothed rack 44 is arranged below the associated rotary damper 14. The upper toothed rack 44 is arranged above the associated rotary damper 14.

The guidance system 1 shown here can be used particularly advantageously in an input system 60. The input system 60 includes an operating element 6 which is connected to the coupling element 13. For better visibility of the coupling device 3, the operating element 6 is not shown in FIG. 1. The input system 60 is connected to an input receiving device 100 in order to make inputs there or to operate it.

FIG. 2 shows the previously described guidance system 1 or the input system 60 in a different representation, in which the operating element 6 is also shown. FIG. 3 shows the operating element 6 in a view from below. The operating element 6 is designed here, for example, to be operated with a finger. Thus, the operating element 6 can be moved with the finger in order to control a cursor on a display or a machine and for example a crane or robot or another input receiving device 100, for example. The control element 6 can also be referred to as a control table or control surface.

The operating element 6 can contain a fingerprint sensor here. When the user touches the surface with his/her fingers, the fingerprint is scanned and only authorized persons can operate the respective device.

Alternatively, the control element 6 can also be equipped with a computer mouse body 16 that is shown purely schematically in FIG. 2. In order to make an input, the computer mouse body 16 is then gripped with one hand, for example, and moved in the way one is used to with a computer mouse. In contrast to a conventional computer mouse, however, the movement of the computer mouse body 16 is guided along the x and y axes and at the same time dampened. As a result, even under very restless conditions and e.g., in an off-highway vehicle reliable inputs possible.

The braking devices 4 shown here are designed magnetorheologically and can be controlled in a targeted manner, so that very different damping torques or braking torques can be set in a targeted manner. For example, the movement of the arms 12, 22 can be blocked by means of the braking devices 4, so that no manual movement is possible when the force is applied as intended. The braking devices 4 can also be set in such a way that there is no or almost no braking torque and freewheeling is possible.

In addition, the braking torque can be adjusted here in real time, so that, for example, a very high-frequency grid or vibration during the movement of the arms 12, 22 is possible. Correct or incorrect entries can be acknowledged by vibrating. Overall, the braking devices 4 enable targeted haptic feedback during operation or during an input. For example, a specific range of motion or an axis 11, 21 can be blocked or released in a targeted manner. This can, for example, prevent unfavorable or even dangerous inputs from being made. In order to be able to select menu items reliably and without looking, a grid can be generated for the movement.

In order to be able to control the braking devices 4 in a targeted manner, the position of the arms 12, 22 is detected, for example, by means of rotary sensors 64. The rotary sensors 64 are integrated here in the rotary dampers 14 and detect their rotary angle position. In this way, the braking torque can be adjusted depending on the angle of rotation. It is also possible to detect the position of the arms 12, 22 using an optical sensor means 74. This enables a particularly high resolution for the scanning. As shown in FIG. 2, the sensor means 74 can e.g., below the control panel 6 can be arranged. For this purpose, for example, a surface over which the operating element 6 is moved is illuminated by means of a light source (LED, laser . . . ) attached to the operating element 6. The reflections are then recorded with an optical sensor and evaluated to determine the relative position. Both rotation sensors 64 and optical sensor means 74 can also be provided.

A control device 8 is provided here for evaluating the sensor signals and for controlling the braking devices 4 as a function of the sensor signals. The control device 8 is fastened to the support structure 32, for example, as shown in FIG. 2. The controller 8 can be coupled to the input receiving device 100.

The guidance system 1 shown here enables guided two-dimensional movements, which are particularly helpful when operating touchpads for computers or other suitable devices. The invention can also be used as a mouse pad with an integrated computer mouse, as a 2-D joystick for e.g., off-highway vehicles or commercial vehicles (e.g., cranes, forklifts, etc.) or for example medical devices. It is also advantageous to make the whole structure (significantly) larger, for example as a movable floor panel on which a chair stands that can be moved (instead of an office chair with wheels). This structure is also conceivable as a human buttocks support in a seat of a simulator (e.g., gaming simulator) or under the entire seat in order to imitate vehicle movements (e.g., braking, acceleration, lateral forces).

The guidance system 1 can also be equipped with a drive device 7 not shown in detail here. Thereby the arms 12, 22 can be moved by a motor, so that specific positioning movements can be carried out. For example, instead of the braking devices 4 shown here, electric drive motors are then provided.

The positioning movements are guided in two axes by the guide device 2. The arms 12, 22 can be positioned particularly precisely since almost the same drive forces are required for both axes 11, 21.

With reference to FIGS. 6 to 12, a particularly advantageous embodiment of the coupling device 3 of the guidance system 1 described above is presented below. The coupling device 3 is equipped here with a coupling element 13 which, in addition to the carriage 23 and the coupling rod 63, also has a coupling unit 9.

The coupling unit 9 here comprises four coupling carriers 19 which are fastened to an upper coupling part 39 and to a lower coupling part 29 and are thereby connected to one another. In relation to their longitudinal axes, the coupling supports 19 run transversely to the x-axis 11 and transversely to the y-axis 21 and span the crossing point 42. The arms 12, 22 run here between the coupling supports 19 and the coupling parts 29, 39.

The coupling carriers 19 are each equipped with two bearing units 49 here, so that one bearing unit 49 of the coupling carrier 19 can roll or possibly slide on the first arm 12 and the second arm 22. As a result, the arms 12, 22 are guided here (in addition to the guide device 2) by the coupling unit 9 in a rolling manner on their outer sides running transversely to the plane of movement.

As shown here by way of example, the bearing units 49 can each be provided by a roller bearing. The bearing units 49 can also be formed by (mounted) rollers or wheels or be provided by plain bearings.

The upper coupling part 39 is provided by the operating element 6 here. The carriage 23 is also accommodated here on the upper coupling part 39. In addition, the coupling rod 63 (not shown here) can be attached to the upper coupling part 39 or can extend through it.

FIG. 11 shows the input system 60, which is arranged on a steering wheel 101 here. In this way, inputs for operating a motor vehicle can be made with the operating element 6. The movement of the operating element 6 is guided with the guide system 1 and can be influenced in a targeted manner at the same time. For example, options in a menu of the on-board computer can be operated with the thumb or another finger. For example, a detent position is provided for each menu item.

The operating element 6 can also be assigned different input functions, for example depending on a driving mode or an operating state or a previously made selection. It can be selected, for example, whether the exterior mirrors, the seats, the air conditioning, the transmission or the drive, the windscreen wipers or the sunroof or the like are adjusted with the operating element 6 instead of the on-board computer. Depending on the range of functions, the movability of the control element 6 is adjusted and assigned, for example, blocking or locking positions and haptic signals.

In the example shown here, the operating element 6 is also equipped with a fingerprint sensor so that operation is only enabled for authorized users. The operating element 6 is designed here as a flat surface or as a plate and consists of a material in which the fingerprint scanner can be integrated particularly easily and well. FIG. 12 shows a use of the guide system 1 in a machine tool 101 and, for example, a milling machine. The guide system 1 is used here as a cross table or cross support for two-axis movement of a workpiece to be machined, so that contours can be milled, for example. Here the fastening surface for the workpiece is provided by the coupling device 3.

The guide system 1 can also be used in microscopes with automatically movable sample holders or sample tables. The microscope is stationary and the specimens are moved in two axes by the specimen table to the desired position. In this case, the sample table is provided by the coupling device 3 or attached thereto.

FIG. 13 shows an exemplary application of the input system 60 when operating a computer. A surface is sketched as the user sees it on his screen, for example, when he runs a program.

The sketch shown here can also be a movement area of a character in a game or an object or tool in CAD drawing or the operating menu of a vehicle, which is controlled via the operating element 6, for example in the steering wheel.

Here, the user moves a cursor 103 or mouse pointer with the input system 60 by moving the operating element 6 accordingly. For example, the operating element 6 is designed as a computer mouse body. While the user makes his inputs with the operating element 6, the movability of the operating element 6 with the guidance system 1 is influenced in a targeted manner. For this purpose, the movements performed with the operating element 6 are registered and evaluated. From this, a prediction for the target area of the movements can be calculated.

The mobility of the operating element 6 can then be adjusted by means of the management system 1 are influenced taking into account the prediction for the target area.

The cursor 103 is to be moved here to the upper target point 36 (A), for example in order to click on something there. With a conventional mouse, the user looks at the screen and pushes the mouse with his hand, first in rough movements and then with finer movements while looking closely at the target point 36. The movement requires the user's concentration and distracts him from his actual task. With the invention, the cursor 103 can be “guided” to the target point 36. This is considerably easier and more comfortable for inexperienced users or users who have to concentrate on other things.

For example, the movement of the operating element 6 is influenced by the guiding device 1 in such a way that the operating element 6 and thus also the cursor 103 are guided along the shortest path 26 to the target point 36. For this purpose, the braking effect of the braking device 1 for the y-axis 21 is increased here, for example, so that the user feels a resistance in this direction.

The user only has to follow the path of least resistance in order to move the cursor 103 along the x-axis 11 or on the shortest path 26 to the target point 36. In this case, the braking effect or damping is adjusted only slightly, so that the user is shown the preferred direction or the shortest path 26 or can feel it on the operating element 6. The braking effect damping can also be set higher or maximum, so that the movement is only possible along the x-axis 11 or on the shortest path 26.

If the lower target point 36 (B) is to be headed for with the cursor 103, a movement of the operating element 6 both along the x-axis 11 and along the y-axis 21 is necessary. Through targeted activation of the braking device 1 for both axes 11, 21, this path 26 can also be indicated haptically or be specified in a fixed manner.

For example, the path 26 is specified or traversed in correspondingly small steps by deliberately braking the movements on the respective axes 11, 21. For this purpose, the braking torque for the axes 11, 21 is adjusted alternately, so that the directions of movement are blocked alternately. The smaller such steps are, the less the user feels that it is not a straight line. With the guide device 1 presented here, it is possible, for example, to realize such small steps that the user perceives the guided movement as a continuous straight line or possibly as a continuous curved path. In this way, the shortest path 26 can also be displayed or specified in order to drive to the lower target point 36 (B). According to this principle, more complex trajectories and, for example, curves or circles or the control of intermediate points can be implemented.

A haptic signal can be conveyed to the user by targeted and in particular high-frequency braking and releasing the mobility of the operating element 6. This can happen, for example, when it deviates from the shortest path 26 or a defined path of movement, or when the cursor 102 is located over the desired target point 36. The user perceives such a haptic signal, for example, as a vibration on his thumb or finger. In addition or as an alternative, optical or acoustic signals can also occur. The haptic signal can also be conveyed by abruptly braking or blocking or by accelerating the movement.

The influencing of the mobility of the control element 6 described here can also be used for other applications and for example for remote control of a drone or the operation of machines and vehicles. Here, too, the user can certain trajectories are specified, on which he can move the control element 6 more easily or exclusively. In addition, haptic, acoustic and/or optical signals can occur if the user moves the operating element 6 in such a way that there would be an unauthorized or critical or also desired or positive reaction from the input receiving device and, for example, from the drone or the machine or the vehicle.

The embodiments described above can also be implemented with partially active or fully active support from the drive device 7. The drive device 7 can be used in addition to or as an alternative to the braking device 1.

The partially active or fully active support can be done depending on the user's condition. If the controller detects that the user's movements are slowing down due to fatigue, the active support is switched in proportion to the fatigue. For example, the controller may also recognize that the user's movements are unsteady or discontinuous. Then the support can also be provided depending on such a state of the user.

The input receiving device and/or the control device 8 can use artificial intelligence to determine the user's desired destination and then define the path 36 or the movement path in order to guide the user there.

Blocking a movement direction is also useful in drawing and CAD programs, for example, if a horizontal or vertical line is to be drawn. Likewise, the drawing of curves or the like can be supported by alternately blocking both directions of movement.

Overall, with the invention through a corresponding combination of braking curves or drive curves along the x-axis 11 and the y-axis 21 any trajectories are simulated. When certain points are reached, such as icons, buttons, lines in drawing programs, etc., there is a short haptic feedback, for example. This can be done, for example, by a brief increase in resistance or by vibration or the like.

With the invention, by targeted and in particular intelligent switching of the braking device 1 or drive device 7, each position within the plane of movement can be approached by the user with targeted support with targeted haptic support. For example, an H-shift of a transmission or another shift gate can also be simulated by a vehicle.

The invention can also be used advantageously for virtual reality and augmented reality. Then, for example, only those movement paths are released which are also present in the virtual or augmented reality, for example paths through spaces or movement spaces of tools or permitted movements during medical interventions.

In all of the configurations, movements of the operating element that are guided in the z-direction and, in particular, that are also braked and/or driven can be provided. For this purpose, the guide device can have a, e.g., 90° offset further guide device.

### LIST OF REFERENCES

1 guidance system
2 guide device
3 coupling device
4 braking device
5 linear guide
6 control element
7 drive device
8 control device
9 coupling unit
11 x-axis
12 arm
13 coupling element
14 rotary damper
15 slide rail
16 computer mouse body
19 coupling carrier
21 y-axis
22 arm
23 carriage
24 gear mechanism
25 slide rail
26 shortest path
29 coupling part
32 support structure
33 passage
34 rack and pinion gear
36 target point
39 coupling part
42 crossing point
43 guide groove
44 toothed rack
49 bearing unit
53 rollers
54 gears
60 input system
63 coupling rod
64 rotary sensor
75 sensor
100 input receiver
101 steering wheel
102 machine tool
103 cursors
120 end region
220 end region

1-27. (canceled)

28. A method for operating an input system, the method comprising:
providing the input system with an operating element that can be displaced in a plane of movement for carrying out inputs into an input receiver and a guidance system for guiding the operating element in two axes in the plane of movement along an x-axis and a y-axis;
influencing the mobility of the operating element in the plane of movement with the guidance system at least during an input;
controlling the operating element with a controllable braking device;
registering movements performed with the operating element during the input as evaluation data, evaluating the evaluation data, and calculating a prediction for a target area of the movements; and
affecting the mobility of the operating element based on the prediction for the target area.

29. The method according to claim 28, wherein the movements are evaluated continuously and the prediction is continuously recalculated using current evaluation data, so that a dynamic prediction is made for the target area.

30. The method according to claim 28, wherein the evaluation of the movements and the prediction of the target area are carried out by means of at least one machine learning algorithm.

31. The method according to claim 28, in which the target area is predicted by evaluating how consistently the movements of the operating element run in a specific direction.

32. The method according to claim 28, wherein the mobility of the operating element is influenced by the guidance system to be moved in the direction of the predicted target area with less resistance than in directions deviating therefrom.

33. The method according to claim 28, wherein the predicted target area is recalculated at least when the operating element is pressed above at least one limit value against the resistance of the braking device.

34. The method according to claim 28, further comprising taking into account whether the input receiver specifies at least one area in which the input is to take place for the prediction of the target area.

35. The method according to claim 30, the method further comprising, wherein the target area is multiple target areas, registering movements of an input directed to one of the target areas; and evaluating the movements using a machine learning algorithm, such that the reliability of the predictions can be continuously optimized.

36. The method according to claim 28, wherein for an input in which the operating element is to be moved to a target point, influencing the mobility of the operating element by the guidance system such that the operating element can only be moved to the destination on a path which deviates from a shortest path by no more than 15%.

37. The method according to claim 28, wherein for an input in which the operating element is to be moved via at least one intermediate point to the destination point, influencing the mobility of the operating element by the guidance system such that the operating element can only be moved via the intermediate point to the target point.

38. The method according to claim 28, wherein for an input in which the operating element is to be moved to a target point:
braking the mobility of the operating element in a targeted manner by the guidance system; and/or
influencing the mobility of the operating element with haptic signals when the operating element approaches the target point, reaches the target point, and/or removes it.

39. The method according to claim 28, wherein for an input in which the operating element is to be moved along a defined path of movement, the mobility of the operating element is
braked in a targeted manner by the guidance system;
influenced with haptic signals and/or
actively supported when the operating element deviates from the movement path by a certain amount.

40. The method according to claim 28, wherein for an input in which the control element is to be moved along a defined path of movement, the mobility of the control element is
released in a targeted manner by the guidance system;
influenced with haptic signals; and/or
actively supported when the operating element approaches the trajectory.

41. The method according to claim 39, wherein:
the braking, the haptic signal, and/or the active support are stronger the greater the deviation from the defined path; and/or
wherein the braking, the haptic signal, and/or the active support are weaker the closer a movement is to the defined path.

42. The method according to claim 28, wherein for an input in which the operating element is to be moved to a target point and/or along a defined movement path, the operating element is actively moved at least temporarily by means of the guidance system.

43. The method according to claim 28, wherein a defined path and/or a target point for an input is determined automatically.

44. The method according to claim 28, wherein the mobility of the operating element is further influenced in dependence on in dependence on what kind of input is made.

45. The method according to claim 28, wherein the mobility of the control element is influenced in dependence on a virtual scenario and the mobility is slowed down more relative to the higher a notional force to be applied in the scenario and/or the more difficult a notional scenario action to be taken is and/or wherein a haptic signal is generated depending on the scenario.

46. The method according to claim 28, wherein the mobility of the operating element is influenced independence on a real situation and the mobility is slowed down or blocked if a critical operating state would otherwise be generated in the real situation.

47. The method according to claim 28, wherein a mobility of the operating element is influenced as a function of an acceleration and/or speed of the operating element, such that movements of the operating element that are too fast or jerky can be dampened.

48. The method according to claim 28, wherein the operating element is braked in a targeted manner as a function of location, such that a grid is haptically simulated and the operating element cannot be moved further than a locking position of the grid without additional effort.

49. The method according to claim 28, wherein the mobility of the operating element is influenced such that the operating element can be displaced along a movement path with a plurality of locking positions and/or location-dependent blocking.

50. The method according to claim 28, wherein the operating element is configured to be pressure-sensitive and the input is at least partially a function of the pressure on the operating element.

51. The method according to claim 28, wherein the control element is configured as a fingerprint sensor and the mobility of the control element is influenced depending on a detected fingerprint.

52. The method according to claim 28, wherein the mobility of the control element is influenced to support the learning of input skills and movements on specific trajectories are specifically supported and/or braked.

53. The method according to claim 28, wherein the mobility of the operating element can be switched between freely movable and blocked with a frequency of at least 10 Hz and preferably at least 50 Hz.

54. The method according to claim 28, wherein the guidance system is controlled with an adaptive algorithm.
